(19) United States
(12) Patent Application Publication
(10) Pub. No.: US 2015/0116541 A1
(43) Pub. Date: Apr. 30, 2015

(54) METHOD AND APPARATUS FOR APPLYING A TAG/IDENTIFICATION TO A PHOTO/VIDEO IMMEDIATELY AFTER CAPTURE

(71) Applicant: Jordan Gilman, Chicago, IL (US)

(72) Inventor: Jordan Gilman, Chicago, IL (US)

(21) Appl. No.: 14/526,038

(22) Filed: Oct. 28, 2014

Related U.S. Application Data
(60) Provisional application No. 61/896,152, filed on Oct. 28, 2013.

(51) Int. Cl. H04N 1/21

(52) U.S. Cl. CPC H04N 1/2112
USPC 348/231.5

(57) ABSTRACT

The method and apparatus for applying and searching for a tag on an image captured by a mobile device. When an image is captured, a user is prompted to select or enter a tag identifying the image in which will be stored in memory in association with the image. The tag can be a new text tag entered by the user or a selection of one of a number of pre-stored or pre-user used tags. To retrieve an image, the user inputs a text tag or selects a tag from a list of tags displayed on a mobile device which were pre-used by the user.

### CROSS REFERENCE TO CO-PENDING APPLICATION

This application claims priority benefit to the Oct. 28, 2013, filing date of co-pending U.S. Provisional Patent Application Ser. No. 61/896,152, the entire contents of which are incorporated herein in their entirety.

### BACKGROUND

In today's digital world, many different mobile devices, including mobile cellular telephones, computer tablets, laptop computers and digital cameras, can easily obtain photographs, video and other content. Such devices save the captured image in memory and automatically add sequential photo ID number and/or a date stamp and possibly related camera settings used when taking the photograph or video. Such devices do not enable a user to provide a unique tag or identification to the captured image to identify the image and to simplify retrieval of the image later.

Some people do spend the time to individually tag items much later after the images are captured, but this is a tedious task and requires storing and grouping the images in different files with appropriate tags or identification. This also requires a certain amount of computer skill which may be beyond most people. As the amount of “untagged” photos increase, the more challenging and time consuming it becomes to tag each photo previously taken.

For current mobile devices with cameras, or even digital cameras, in order for a photographer to find a photo they have taken, they either need to remember the date that the photo was taken, or visually find it in the camera memory by scrolling through a photo of thumbnails on the camera for mobile device. Such items such as “favorite” photos, photo streams and more provide a means to identify a group/tagged photos, but limited on the type of tags applied and when the tag is applied. For example, you can't mark a photo as favorite until you go back to the gallery to preview the photo.

If the photographer has taken the time to tag the photos via separate third party application, the photographer still must browse through all of the tagged photos when placing the tags or identification on the photos.

### SUMMARY

The present method and apparatus uniquely provides an opportunity for a user, after capturing an image using a camera on a mobile device or a digital camera, to add a tag or other identification to the photo before the photo is stored in the device memory. Doing this immediately after taking the photo or video streamlines the process for organizing the photos for future retrieval.

### BRIEF DESCRIPTION OF THE DRAWINGS

The various features, advantages and other uses of the present method and apparatus will become more apparent by referring to the following detailed description and drawing in which:

FIG. 1 is a pictorial representation of a mobile device incorporating the present method and apparatus;

FIG. 2 is a pictorial representation of the method and apparatus used to search for a previously taken and stored image which has been identified with a tag or identification, along with a number of other related images;

FIG. 3 is a flow diagram of the method and apparatus used to download and install the application program in a mobile device;

FIG. 4 is a flow diagram of the method and apparatus for prompting the user to add a tag immediately after a photograph is taken;

FIG. 6 is a flow diagram depicting the method and apparatus for user to search for a tagged photo or group of tag photos; and

FIG. 5 is a flow diagram depicting the method and apparatus suggesting tag options to a user; and

FIG. 7 is a block diagram of an example of the hardware configuration for the user device.

### DETAILED DESCRIPTION

The present method and apparatus allow a tag or other identification to be applied to an image, such as a photo or video, captured by a camera in a mobile device or by a digital camera immediately upon capture of the image without going to the photo gallery thereby simplifying later retrieval of the image.

The method and apparatus can be employed with any mobile device having camera or image taking capabilities. Such mobile devices include, for example, a mobile cellular telephone, a computer tablet, a computer laptop, a digital camera, and other smart devices such as watches, drones, and smart glasses.

FIG. 7 is a block diagram of an example of a hardware configuration for a user device 100. Other computers and/or devices described herein can be implemented using a similar configuration.

The CPU 110 of the user device 100 can be a conventional central processing unit. Alternatively, the CPU 110 can be any other type of device, or multiple devices, capable of manipulating or processing information now-existing or hereafter developed. Although the disclosed examples can be practiced with a single processor as shown, e.g. CPU 110, advantages in speed and efficiency can be achieved using more than one processor.

The user device 100 can include memory 120, such as a random access memory device (RAM). Any other suitable type of storage device can be used as the memory 120. The memory 1020 can include code and data 122, one or more application programs 124, and an operating system 126, all of which can be accessed by the CPU 110 using a bus 130. The application programs 124 can include programs that permit the CPU 110 to perform the methods described here.

A storage device 140 can be optionally provided in the form of any suitable computer readable medium, such as a memory device, a flash drive or an optical drive. One or more input devices 150, such as a keyboard, a mouse, or a gesture sensitive input device, receive user inputs and can output signals or data indicative of the user inputs to the CPU 110. One or more output devices can be provided, such as a display device 160. The display device 160, such as a liquid crystal display (LCD) or a cathode-ray tube (CRT), allows output to be presented to a user.

Although the CPU 110 and the memory 120 of the user device 110 are depicted as being integrated into a single unit, other configurations can be utilized. The operations of the CPU 110 can be distributed across multiple machines (each machine having one or more of processors) which can be coupled directly or across a local area or other network. The memory 120 can be distributed across multiple machines such as network-based memory or memory in multiple machines performing the operations of the user device 100. Although depicted here as a single bus 130, the bus 130 of the user device 100 can be composed of multiple buses. Further, the storage device 140 can be directly coupled to the other components of the user device 100 or can be accessed via a network and can comprise a single integrated unit such as a memory card or multiple units such as multiple memory cards. The user device 100 can thus be implemented in a wide variety of configurations.

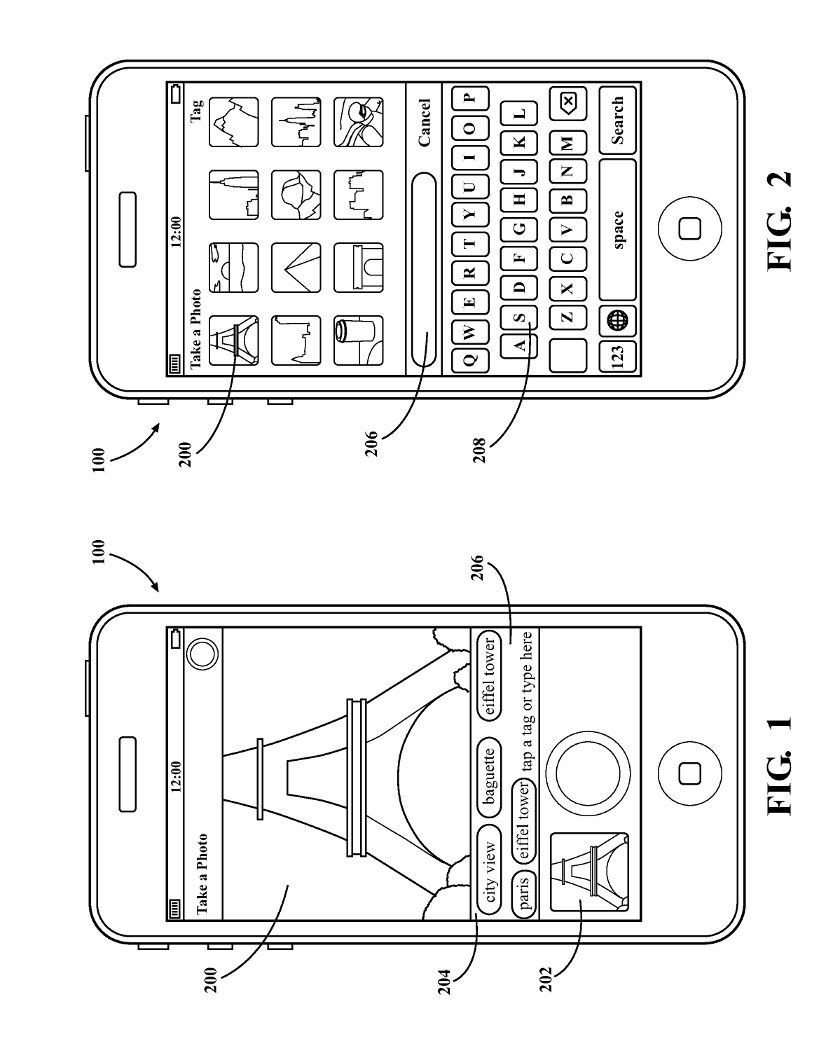

Referring now to FIG. 1, there is depicted the mobile device 100 in the form of a cellular telephone with a camera for taking images. In image 200 has been taken by the mobile device 100 and appears in a thumbnail 202 at the bottom of the display screen. The method and apparatus display, as described hereafter, a plurality of previously used or pre-stored image tags 204 to assist the user in later retrieving the image from memory storage. Alternatively, a space is provided on the display screen 206 for the user to type in a tag or identification, both hereafter referred to a tag.

After taking the photo, the app would automatically display the list of suggested tags to be assigned to this photo, allowing them to instantly categorize/tag the photos for future retrieval. The speed and simplicity of how the tags are applied to the photo by the end user and/or automatically is an advantage. When the user saves a word document, it prompts the user to save to a file name you remember; so you need to make sure that process and this are not confused.

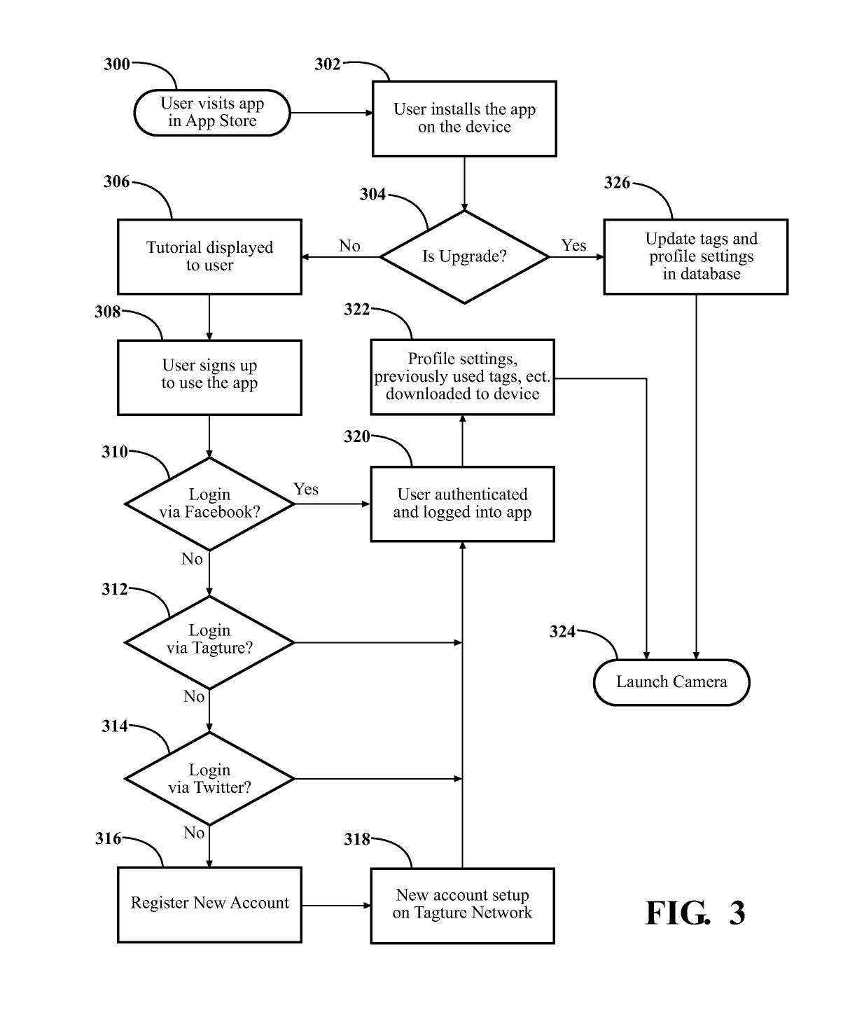

In FIG. 2, the image 200 by itself or with a plurality of related images taken at the same time or of the same object or person or subject, are displayed in thumbnail form on the display screen of the mobile device 100. The blank space 206 allows the user to search for a previously tagged photo, such as photo 200, by typing in a tag/keyword via the keyboard 208.

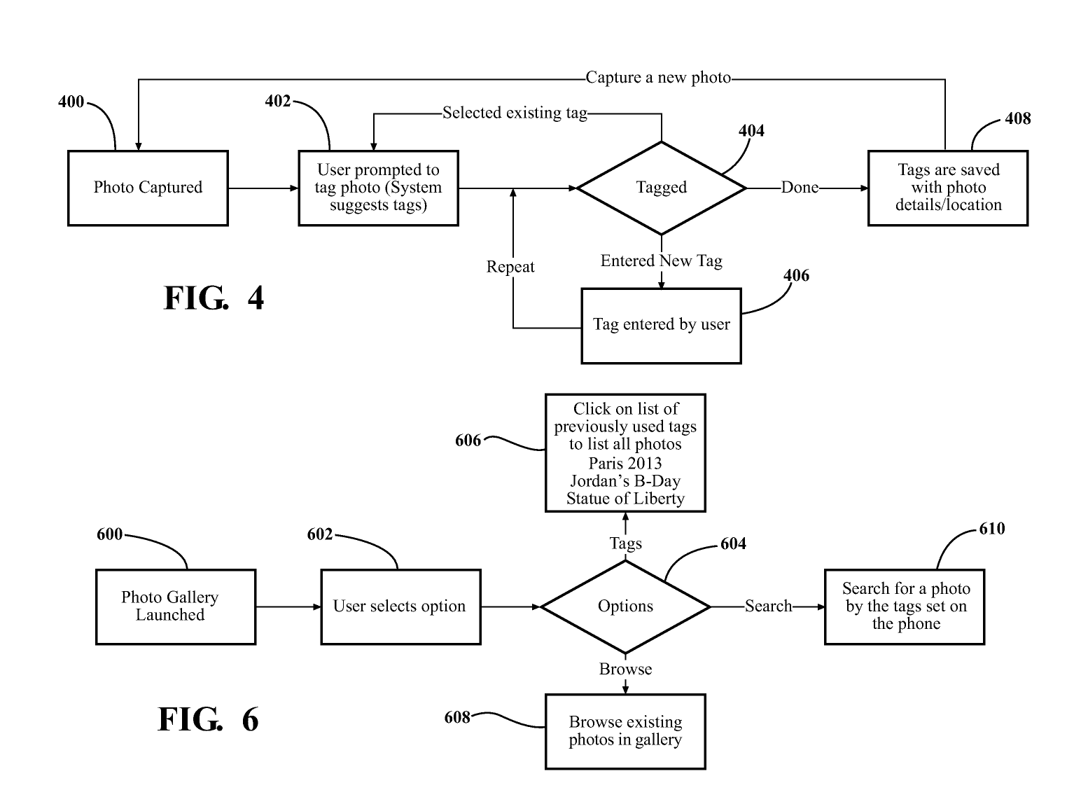

To set up and install the application embodying the method and apparatus, as shown in FIG. 3, the user visits web based application store in step 300 and selects the image tag app. The user than selects and installs the app in step 302 on his mobile device 100. The application queries whether the installation is an upgrade in step 304. If the installation is not an upgrade, a use tutorial is displayed to the user in step 306 describing how to use the image tag app. The user signs up in step 308 to use the app. The app allows user login by a plurality of browsers, such as via Facebook in step 310, Tagture in step 312, and Twitter in step 314 or to register as a new account in step 316 on the image tag network. In step 316, when a new account is registered, the new account set-up is displayed and followed in step 318 from the Tagture Network.

After any of steps 310, 312, 314, and 318, the user is authenticated in step 320 and is logged into the app. User profile settings, previously used tags, etc., are then downloaded to mobile device 100 in step 322. The app launches the camera in the mobile device 100 for image taking in step 324.

Referring back to step 304, if the installation of the app is an upgrade as determined in step 304, the app updates, tags and user profile setting in the network database in step 326 before launching the camera in step 324.

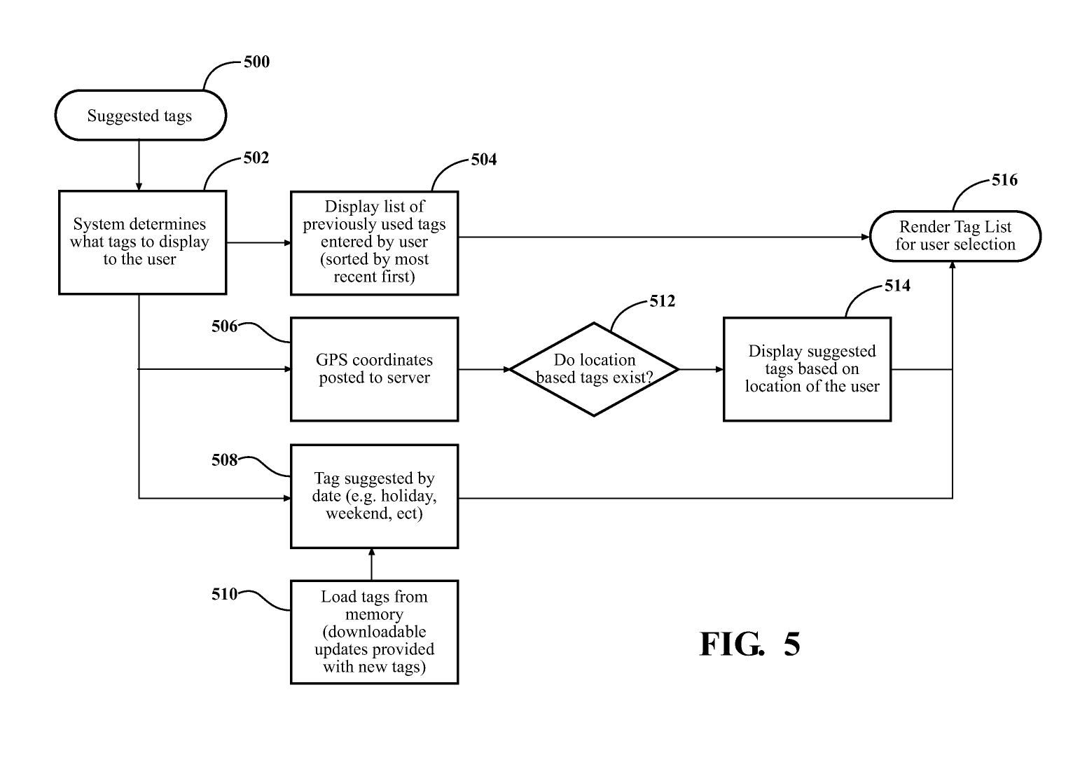

FIG. 4 depicts the image capture and tag assignment steps of the present method and apparatus. A new photo or image is captured in step 400 by the camera in the mobile device 100. The user is prompted to tag the captured photo in step 402. In order to tag the photo in step 404, the user is prompted to enter a new tag which can be done in step 406 or to select an existing tag. When either an existing tag or new tag is selected or entered into the app on the mobile device 100, the tag is saved with the photo and the camera settings in step 408, typically in the memory 140 of the mobile device 100.

As shown in FIG. 4, applying a tag to a captured photo or other image in step 402 can include the application suggesting tags for the captured photo to the user in step 500. When suggesting tags, the CPU determines which tags to display to the user in step 502. This determination can include a selection of a display of a list of previously used tags entered by the user, sorted by the most recent tag first, in step 504. Alternatively or in addition to the list of previously used tags, the application can suggest GPS coordinates where the image was taken in 506. In step 508 the suggested tags are by date, where the date can be either a numerical date or an indication of a significant date, such as Christmas, 4^{th} of July, etc.

Pre-stored tags can be provided by the app in step 510. The pre-stored tags are downloadable with updates to the app., or the cloud or external storage media as described above.

After step 506 is executed, the app determines in step 512 if location based tags exist or are available. This would require, for example, the mobile device to have GPS location capabilities.

If location tags do exist as determined in step 512, the app in step 514 displays suggested tags based on the location of the user. Such location tags can include the GPS coordinates, the city, state and/or country, the building, monument or location name, etc., in the image.

After steps 514 or 508 have been executed, the app renders the tag list for user selection in step 516 via the display on the mobile device 100.

In step 600, the photo gallery on the mobile device is launched. The user selects an option in 602 defining how he wishes to locate a stored image. In step 604, the user is presented with two options, namely, to click on a list of previously used tags entered by the user in step 606. Such previously used tags are those directly entered by the user or selected by the user as one of the tags suggested by the app. Alternatively, the user can browse all of the photos in the photo gallery in step 608 to locate a particular tag.

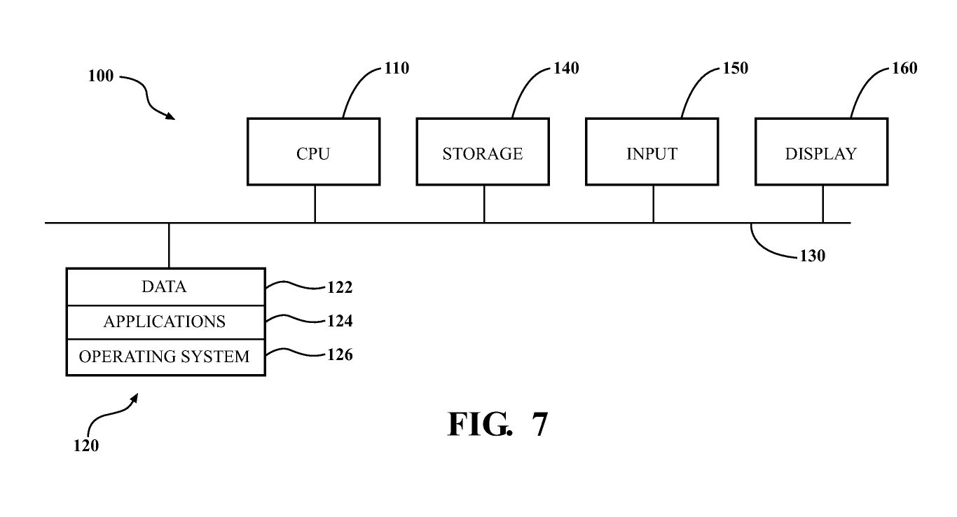

If the user desires to review the various photos or videos he has taken, the user can call up a list of all previously used tags in step 604 in FIG. 6. This tag list includes the tags which were chosen by the user, either by being independently entered by the user or by selection of one of the tags suggested by the app.

In step 610, the app searches for the photo or photos which are associated with the tag entered by the user from step 604 and displays the selected photo or photos on the display of the mobile device 100.

What is claimed is:

1. A method comprising:
prompting a user of a device having camera capabilities for capturing an image and storing the captured image in a memory, to enter a tag assisting the user in identifying the captured image;
associating the tag entered by the user with the captured image in memory.

2. The method of claim 1 further comprising:
providing one of a text entered space on the device for entry of a tag by the user and suggesting at least one tag from a list of stored tags.

3. The method of claim 1 wherein the step of suggesting tags comprises:
presenting at least one tag from a group of tags including pre-used tag entered by the user, a GPS location of the captured image, and date related tags.

4. The method of claim 1 further comprising:
providing a tag search selection on a mobile device; and
when the tag selection feature is selected by a user, providing a tag selection input for the user.

5. The method of claim 1 wherein the tag selection input comprising:
displaying a list of all tags entered by the user.

6. The method of claim 1 wherein the tag selection input comprising:
a text input for the user to input a text based tag.

7. The method of claim 1 wherein the method is form on a user device formed of
one of a mobile cellular telephone, a mobile computer tablet, a mobile computer, a digital camera, smart watches, drones and smart glasses.

8. The method of claim 1 comprising:
the step of prompting a user to enter a tag occurs when the captured image is displayed on the mobile device approximate the time of capturing the image by the mobile device.

9. An apparatus comprising:
a camera for capturing images;
a processor coupled to the camera;
a memory coupled to the camera and the processor for storing images captured by the camera under control of the processor;
the processor executing program instructions to:
when an image is captured by the camera, displaying the image on the display of a mobile device carrying the camera which captured the image to enter a tag to identify the captured image; and
upon entry of the tag, the processor associating the tag with the captured image in the memory.

10. The apparatus of claim 9 further comprising:
the memory containing a plurality of pre-stored tags.

11. The apparatus of claim 9 further comprising:
the memory containing a list of all tags previously entered by a user of the mobile device.

12. The apparatus of claim 9 further comprising:
the camera carried in a mobile device, the mobile device having GPS capabilities to identify a current location of the mobile device:
the processor, coupled to the GPS of the mobile device, for suggesting current GPS coordinate of the mobile device as a tag.

13. The apparatus of claim 12 further comprising:
one of the mobile devices being one of a mobile cellular telephone, mobile computer tablet, a mobile laptop computer, a digital camera, smart watches, drones and smart glasses.
